(19) United States
(12) Patent Application Publication
(10) Pub. No.: US 2025/0267223 A1
(43) Pub. Date: Aug. 21, 2025

(54) IMAGE READING DEVICE, IMAGE FORMING APPARATUS, AND IMAGE READING METHOD

(71) Applicant: KYOCERA Document Solutions Inc., Osaka (JP)

(72) Inventor: TRUNG MANH TRAN, Osaka (JP)

(21) Appl. No.: 19/036,590

(22) Filed: Jan. 24, 2025

(30) Foreign Application Priority Data
Feb. 15, 2024 (JP) 2024-020835

(51) Int. Cl. H04N 1/00; H04N 1/028

(52) U.S. Cl. CPC H04N 1/00816; H04N 1/00618; H04N 1/02825; H04N 2201/0094

(57) ABSTRACT

An image reading device includes: a first reading portion configured to read an image of a sheet; a second reading portion disposed below a contact glass; a first white reference plate disposed in a conveying portion to face the first reading portion; a second white reference plate disposed in the conveying portion at a reference position that can face the second reading portion; and a control portion configured to light a first light source and generate first white reference data by using reflected light reflected from the first white reference plate, and light a second light source and generate second white reference data by using reflected light reflected from the second white reference plate. The control portion controls the first light source and the second light source such that a lighting time of the first light source does not overlap with a lighting time of the second light source.

### INCORPORATION BY REFERENCE

This application is based upon and claims the benefit of priority from the corresponding Japanese Patent Application No. 2024-020835 filed on Feb. 15, 2024, the entire contents of which are incorporated herein by reference.

### BACKGROUND

The present disclosure relates to an image reading device, an image forming apparatus, and an image reading method for reading images of both surfaces of a conveyed document sheet.

There is known an image processing apparatus including a sheet conveying device for conveying a document sheet that is a reading object. In addition, there is known an image reading device including a plurality of reading portions for reading images of both surfaces (a front surface and a back surface) of a document sheet. For example, the image reading device, with a configuration of including, in a conveyance path of an ADF, a CIS sensor (back surface CIS sensor) for reading a back surface image and a CIS sensor (front surface CIS sensor) for reading a front surface image, reads images of both surfaces of the document sheet in one path.

### SUMMARY

An image reading device according to an aspect of the present disclosure includes: a conveying portion configured to convey a sheet; a first reading portion disposed in the conveying portion and configured to read an image of a first surface of the sheet conveyed by the conveying portion; a second reading portion disposed below a contact glass in such a way as to be reciprocally movable along a scanning direction and configured to read an image of a second surface of the sheet; a first white reference plate disposed in the conveying portion to face the first reading portion; a second white reference plate disposed in the conveying portion at a reference position that can face the second reading portion; and a control portion configured to light a first light source included in the first reading portion and generate first white reference data by using reflected light reflected from the first white reference plate, and light a second light source included in the second reading portion and generate second white reference data by using reflected light reflected from the second white reference plate. The control portion controls the first light source and the second light source such that a lighting time of the first light source does not overlap with a lighting time of the second light source.

An image forming apparatus according to another aspect of the present disclosure includes the image reading device and an image forming portion configured to form an image on the sheet.

An image reading method according to a further aspect of the present disclosure is for, in an image reading device including: a conveying portion configured to convey a sheet; a first reading portion disposed in the conveying portion and configured to read an image of a first surface of the sheet conveyed by the conveying portion; a second reading portion disposed below a contact glass in such a way as to be reciprocally movable along a scanning direction and configured to read an image of a second surface of the sheet; a first white reference plate disposed in the conveying portion to face the first reading portion; and a second white reference plate disposed in the conveying portion at a reference position that can face the second reading portion, reading the image, the image reading method including a control step of lighting a first light source included in the first reading portion and generating first white reference data by using reflected light reflected from the first white reference plate, and lighting a second light source included in the second reading portion and generating second white reference data by using reflected light reflected from the second white reference plate, wherein in the control step, the first light source and the second light source are controlled such that a lighting time of the first light source does not overlap with a lighting time of the second light source.

According to the present disclosure, it is possible to provide an image reading device, an image forming apparatus, and an image reading method that can reduce the image reading time required for the initial document sheet and prevent low-quality images from being formed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of the present disclosure.

FIG. 2 is a diagram showing a configuration of an ADF and an image reading portion of the image forming apparatus according to the embodiment of the present disclosure.

FIG. 3 is a diagram schematically showing positional relationship among CIS sensors and a white reference plate and relationship with control time of a light source.

FIG. 4 is a flowchart showing an example of an image reading process executed by an image forming apparatus according to a practical example 1 of the present disclosure.

FIG. 5 is a flowchart showing an example of an image reading process executed by an image forming apparatus according to a practical example 2 of the present disclosure.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

### Configuration of Image Forming Apparatus 100

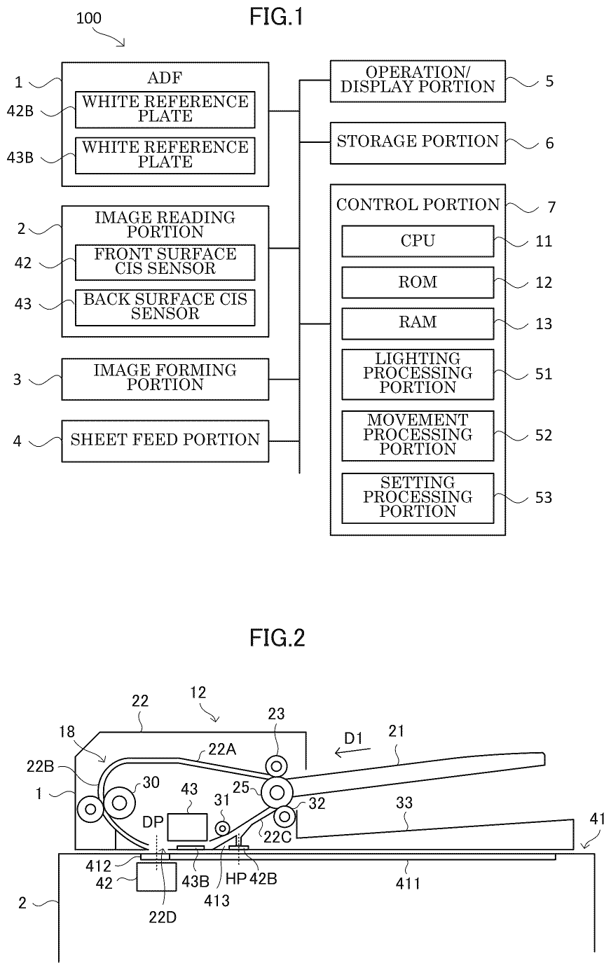

First, a configuration of an image forming apparatus 100 according to an embodiment of the present disclosure is described with reference to FIG. 1.

The image forming apparatus 100 is a multifunction peripheral having a plurality of functions such as a scan function for reading an image from a document sheet, a print function for forming an image based on image data, a facsimile function, and a copy function. The image forming apparatus 100 is an example of an image forming apparatus of the present disclosure. It is noted that the image forming apparatus of the present disclosure may be a scanner, a facsimile device, a copier, or the like.

As shown in FIG. 1, the image forming apparatus 100 includes an ADF (Auto Document Feeder) 1, an image reading portion 2, an image forming portion 3, a sheet feed portion 4, an operation/display portion 5, a storage portion 6, and a control portion 7.

The ADF 1 is a sheet conveying device for conveying a document sheet (an example of a sheet of the present disclosure) that is a reading object. The ADF 1 executes a document sheet conveyance process in accordance with a control instruction from the control portion 7.

The image reading portion 2 reads an image from a document sheet conveyed by the ADF 1. In addition, the image reading portion 2 reads an image from a document sheet placed on a document sheet table 41 (see FIG. 2).

The image forming portion 3 forms an image by an electrophotographic method on a sheet supplied from the sheet feed portion 4. For example, the image forming portion 3 includes a photoconductor drum, a charging roller, a laser scanning unit, a developing device, a transfer roller, a cleaning device, a fixing device, and a sheet discharge tray.

The sheet feed portion 4 supplies a sheet to the image forming portion 3. For example, the sheet feed portion 4 includes a sheet feed cassette, a manual feed tray, a sheet conveyance path, and a plurality of conveyance rollers.

The operation/display portion 5 is a user interface of the image forming apparatus 100. For example, the operation/display portion 5 includes a display portion and an operation portion, wherein the display portion, such as a liquid crystal display, is configured to display a variety of information in response to control instructions from the control portion 7, and the operation portion, such as operation keys or a touch panel, is configured to input a variety of information to the control portion 7 in response to user operations.

The storage portion 6 is a nonvolatile storage device. For example, the storage portion 6 is a storage device such as: a nonvolatile memory such as a flash memory or an EEPROM (registered trademark); an SSD (Solid State Drive); or an HDD (Hard Disk Drive).

The control portion 7 comprehensively controls the image forming apparatus 100. As shown in FIG. 1, the control portion 7 includes a CPU 11, a ROM 12, and a RAM 13. The CPU 11 is a processor that executes various types of calculation processes. The ROM 12 is a nonvolatile storage device in which are preliminarily stored various types of information such as control programs for causing the CPU 11 to execute various processes. The RAM 13 is a volatile or nonvolatile storage device that is used as a temporary storage memory (working area) for the various types of processes executed by the CPU 11. In the control portion 7, the CPU 11 executes the various types of control programs preliminarily stored in the ROM 12. This allows the control portion 7 to comprehensively control the image forming apparatus 100.

### Configuration of ADF 1 and Image Reading Portion 2

Next, with reference to FIG. 1 and FIG. 2, a configuration of the ADF 1 and the image reading portion 2 is described. Here, FIG. 2 is a cross section diagram showing the configuration of the ADF 1 and the image reading portion 2. The ADF 1 and the image reading portion 2 are an example of an image reading device of the present disclosure.

As shown in FIG. 2, the ADF 1 includes a document sheet placement portion 21, a housing 22, a pickup roller 23, a separation roller 25, a first conveyance roller 30, a second conveyance roller 31, a discharge roller 32, and a discharge portion 33.

A document sheet that is a conveyance object is placed on the document sheet placement portion 21. In the ADF 1, the document sheet placed on the document sheet placement portion 21 is conveyed in a conveyance direction D1 shown in FIG. 2.

The document sheet placement portion 21 is provided with a detection portion (not shown). The detection portion detects presence or absence of a document sheet on the document sheet placement portion 21. For example, the detection portion is a reflection-type optical sensor provided on a document sheet placement surface of the document sheet placement portion 21.

In addition, the document sheet placement portion 21 is provided with a lift plate (not shown). The lift plate lifts a bunch of document sheets placed on the document sheet placement portion 21 up to a position of contacting with the pickup roller 23.

The housing 22 stores rollers and the like used to convey the document sheet. As shown in FIG. 2, a first conveyance path 22A and a second conveyance path 22C for guiding the document sheet are formed inside the housing 22. The second conveyance path 22C, including a curved portion 22B curved from the first conveyance path 22A, reaches the discharge portion 33. The curved portion 22B is curved with a curvature with which the document sheet can make a U-turn in the housing 22.

In the ADF 1, the document sheet placed on the document sheet placement portion 21 is conveyed along a conveyance route that travels the first conveyance path 22A, the curved portion 22B, and the second conveyance path 22C to reach the discharge portion 33.

The pickup roller 23 is provided above the document sheet placement portion 21. The pickup roller 23 contacts with a surface (an upper surface) of a document sheet at the top of the bunch of document sheets lifted by the lift plate, and conveys the document sheet in the conveyance direction D1. The sheet feed belt (not shown) is provided in the first conveyance path 22A, contacts with a surface of the document sheet conveyed in the conveyance direction D1 by the pickup roller 23, and conveys the document sheet toward the downstream in the conveyance direction D1.

The first conveyance roller 30 is provided at the curved portion 22B. Upon contacting with a document sheet, the first conveyance roller 30 conveys the document sheet toward the downstream in the conveyance direction D1.

The opening portion 22D is formed downstream of the first conveyance roller 30 in the second conveyance path 22C in the conveyance direction D1. At the opening portion 22D, a front surface CIS sensor 42 (see FIG. 1 and FIG. 2) of the image reading portion 2 reads an image of a front surface of the document sheet passing over the opening portion 22D.

The second conveyance roller 31 is provided downstream of the opening portion 22D in the second conveyance path 22C in the conveyance direction D1. Upon contacting with the document sheet conveyed by the first conveyance roller 30, the second conveyance roller 31 conveys the document sheet toward the downstream in the conveyance direction D1.

The discharge roller 32 is provided downstream of the second conveyance roller 31 in the second conveyance path 22C in the conveyance direction D1. Upon contacting with the document sheet conveyed by the second conveyance roller 31, the discharge roller 32 discharges the document sheet to the discharge portion 33. The document sheet discharged by the discharge roller 32 is stacked on the discharge portion 33.

As shown in FIG. 1 and FIG. 2, the image reading portion 2 includes the document sheet table 41, the front surface CIS sensor 42, and a back surface CIS sensor 43.

The front surface CIS sensor 42 is a reading unit of the contact image sensor type, and includes in its inside a light source (LED), a condenser lens composed of a plurality of lenses, and a CMOS sensor. In the front surface CIS sensor 42, light emitted from the light source is passed through reading glass to be reflected on the document sheet, the reflected light (image light) is passed through the reading glass again to be condensed by the condenser lens, and an image is formed on the CMOS sensor. In the CMOS sensor, the image light formed as the image is broken into pixels, converted into electric signals corresponding to the density of each pixel, and image reading is performed. The back surface CIS sensor 43 has the same configuration as the front surface CIS sensor, and includes a light source (LED), a condenser lens, and a CMOS sensor.

A document sheet that is a reading object is placed on the document sheet table 41. The document sheet table 41 is provided at an upper part of a housing of the image forming apparatus 100. The ADF 1 is provided in an openable and closable manner with respect to the document sheet table 41, and also serves as a document sheet cover that supports one surface of a document sheet placed on a first contact glass 411 of the document sheet table 41.

As shown in FIG. 2, the document sheet table 41 includes the first contact glass 411, a second contact glass 412, and a guide member 413. A document sheet from which an image is to be read by the front surface CIS sensor 42 is placed on the first contact glass 411. In a state where the ADF 1 is closed to the document sheet table 41, the second contact glass 412 and the guide member 413 face the opening portion 22D of the housing 22 and form a part of the second conveyance path 22C. The second contact glass 412 transmits the light that has been emitted from the front surface CIS sensor 42 toward the opening portion 22D, and transmits the light reflected from the document sheet. The guide member 413, at a position downstream of the second contact glass 412 in the conveyance direction D1, guides the document sheet to the discharge roller 32.

The front surface CIS sensor 42 is provided below the first contact glass 411 and the second contact glass 412. The front surface CIS sensor 42 is elongated in the depth direction of FIG. 2, and is provided reciprocally movable along the left/right direction of FIG. 2. In a state of being disposed at a position (reading position DP) below the second contact glass 412, the front surface CIS sensor 42 reads an image of a front surface of a document sheet conveyed by the ADF 1. Specifically, the front surface CIS sensor 42 outputs an analog signal corresponding to the image read from the front surface of the document sheet. The analog signal output from the front surface CIS sensor 42 is converted into a digital signal (image data) by an analog front-end circuit (not shown) and is input to the control portion 7.

In addition, a white reference plate 42B (front surface shading plate) used for a shading correction by the front surface CIS sensor 42 is disposed at a position (reference position HP) under the guide member 413. That is, the white reference plate 42B is disposed at the reference position HP that can face the front surface CIS sensor 42 in the ADF 1. In a state of being disposed at the reference position HP, the front surface CIS sensor 42 lights the light source and generates white reference data by using reflected light reflected from the white reference plate 42B.

The back surface CIS sensor 43 is disposed in the ADF 1, and reads an image of a back surface of a document sheet conveyed by the ADF 1. The back surface CIS sensor 43 is provided at a position that faces the front surface CIS sensor 42 via the opening portion 22D. Specifically, as shown in FIG. 2, the back surface CIS sensor 43 is provided downstream of the curved portion 22B and the first conveyance roller 30 and upstream of the second conveyance roller 31 in the conveyance direction D1. In addition, the back surface CIS sensor 43 is provided downstream of the reading position DP and upstream of the reference position HP. The back surface CIS sensor 43 outputs an analog signal corresponding to the image read from the back surface of the document sheet. The analog signal output from the back surface CIS sensor 43 is converted into a digital signal (image data) by an analog front-end circuit (not shown) and is input to the control portion 7.

In addition, a white reference plate 43B (back surface shading plate) used for a shading correction by the back surface CIS sensor 43 is disposed at a position facing the back surface CIS sensor 43. The white reference plate 43B is disposed between the first contact glass 411 and the back surface CIS sensor 43. The back surface CIS sensor 43 lights the light source and generates white reference data by using reflected light reflected from the white reference plate 43B.

As described above, the back surface CIS sensor 43 and the white reference plate 43B are disposed downstream, in a document sheet conveyance direction, of the reading position DP at which the front surface CIS sensor 42 reads an image of a document sheet, and the white reference plate 42B is disposed downstream of the back surface CIS sensor 43 and the white reference plate 43B in the document sheet conveyance direction.

By adopting the above-described structure where the front surface CIS sensor 42 and the back surface CIS sensor 43 are disposed to face each other, it is possible to downsize the image reading device (the ADF 1 and the image reading portion 2) and reduce the cost. Here, in the above-described structure, if, in order to reduce the image reading time required for the initial document sheet (First Scan Operating Time: FSOT), a setting such as generating the white reference data for the front surface CIS sensor and a setting such as generating the white reference data for the back surface CIS sensor are performed at approximately the same timing, light-emitting times of the light sources (LED) of the two CIS sensors overlap with each other, thereby failing to generate appropriate white reference data, causing a problem of forming low-quality images. On the other hand, in the image forming apparatus 100 according to the embodiment of the present disclosure, as described below, it is possible to reduce the image reading time required for the initial document sheet and prevent low-quality images from being formed.

### Configuration of Control Portion 7

Next, a configuration of the control portion 7 is described in more detail with reference to FIG. 1. As shown in FIG. 1, the control portion 7 includes a lighting processing portion 51, a movement processing portion 52, and a setting processing portion 53.

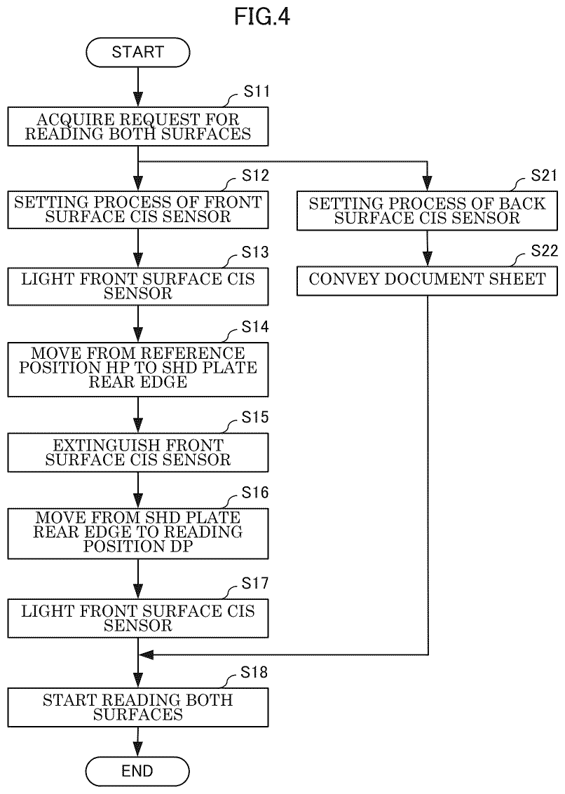

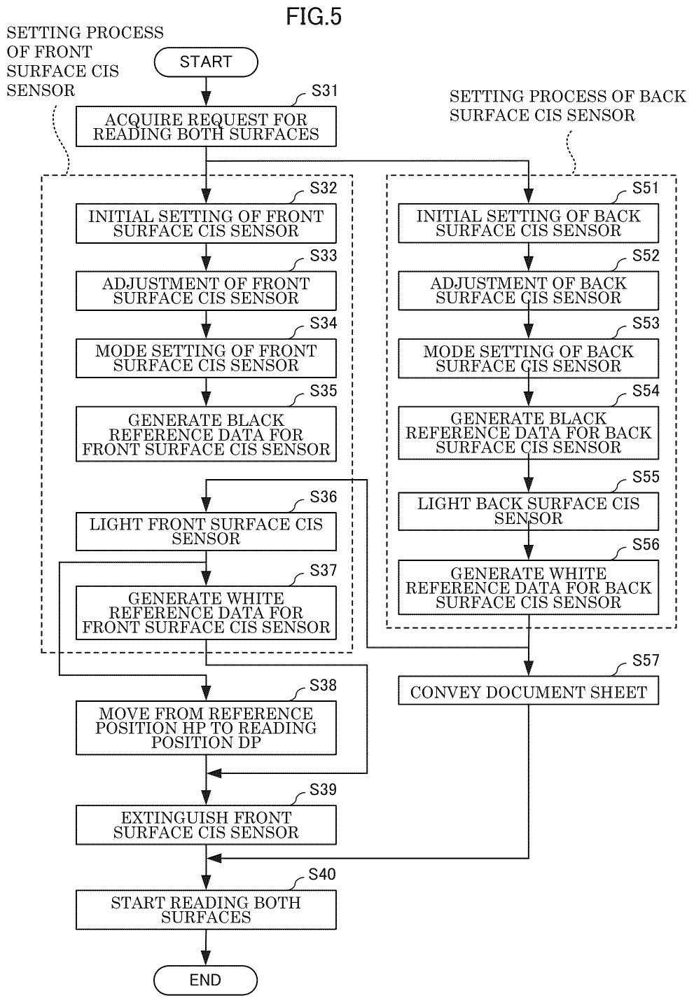

Specifically, an image reading program for causing the CPU 11 to execute an image reading process (see FIG. 4 and FIG. 5) described below is preliminarily stored in the ROM 12. The control portion 7 functions as the lighting processing portion 51, the movement processing portion 52, and the setting processing portion 53 by executing the image reading program stored in the ROM 12. Here, a device including the ADF 1, the image reading portion 2, and the control portion 7 is an example of the image reading device of the present disclosure. It is noted that the present disclosure may be realized by a device including the image reading portion 2 and the control portion 7.

It is noted that the image reading program may be recorded on a non-transitory computer-readable recording medium such as a CD, a DVD, or a flash memory, and may be read from the recording medium and stored in a storage device such as the storage portion 6. In addition, the lighting processing portion 51, the movement processing portion 52, and the setting processing portion 53 may be composed of an electronic circuit such as an integrated circuit (ASIC).

Here, the control portion 7 performs a process (setting process) required for initial setting and adjustment of the front surface CIS sensor 42 and the back surface CIS sensor 43 at various timings such as when the image forming apparatus 100 is powered on, when it returns from a power saving state (sleep mode), when a predetermined change in temperature or humidity is observed, and when the image reading process is started. In addition, in the setting process, the control portion 7 lights the light sources of the front surface CIS sensor 42 and the back surface CIS sensor 43 and generates white reference data by using reflected lights reflected from the white reference plate 42B and the white reference plate 43B.

Specifically, the control portion 7 lights the light source of the front surface CIS sensor 42 and generates white reference data for the front surface CIS sensor 42 (white reference data for images read from the front surface) by using reflected light reflected from the white reference plate 42B, and lights the light source of the back surface CIS sensor 43 and generates white reference data for the back surface CIS sensor 43 (white reference data for images read from the back surface) by using reflected light reflected from the white reference plate 43B. In addition, the control portion 7 controls the light sources such that the lighting time of the light source of the front surface CIS sensor 42 does not overlap with the lighting time of the light source of the back surface CIS sensor 43.

The lighting processing portion 51, the movement processing portion 52, and the setting processing portion 53 included in the control portion 7 respectively execute processes for generating the white reference data.

The lighting processing portion 51 controls lighting (ON) and extinguishing (OFF) of each of the light sources of the front surface CIS sensor 42 and the back surface CIS sensor 43.

The movement processing portion 52 controls the movement of the front surface CIS sensor 42. Specifically, in the setting process, the movement processing portion 52 moves the front surface CIS sensor 42 between the reference position HP and the reading position DP shown in FIG. 2 in a scanning direction (left/right direction in FIG. 2).

The setting processing portion 53 performs the initial setting, adjustment and the like of each of the front surface CIS sensor 42 and the back surface CIS sensor 43. In addition, the setting processing portion 53 generates reference data (white reference data, black reference data).

Having generated the white reference data, the control portion 7 performs the shading correction by using the white reference data during image reading. That is, the control portion 7 generates the white reference data before reading an image from a conveyed document sheet, and executes the shading correction of the read image by using the generated white reference data.

For example, the control portion 7 generates the white reference data and executes the image reading process by having configurations of practical examples 1 and 2 described below. The control portion 7 may have a configuration of either one of the practical example 1 and the practical example 2, or may have both configurations and switch between them as necessary.

### Image Reading Process According to Practical Example 1

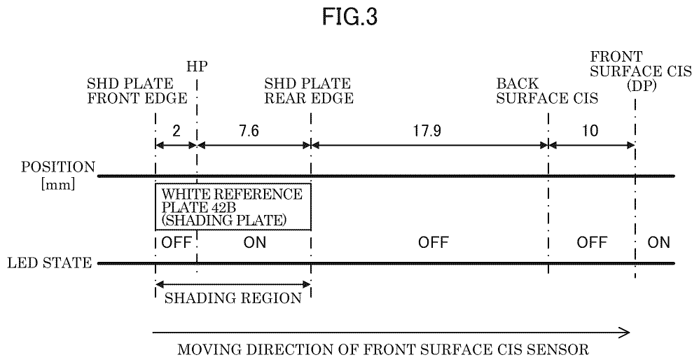

FIG. 3 and FIG. 4 show an example of the procedure of an image reading process executed by the control portion 7 in the image forming apparatus 100 according to the practical example 1.

It is noted that the present disclosure can be recognized as an image reading method (the image reading method of the present disclosure) that executes one or more steps included in the image reading process. In addition, one or more steps included in the image reading process described here may be omitted as necessary. In addition, steps of the image reading process may be executed in different orders as far as the same action effect is obtained. Furthermore, although in this description the control portion 7 executes the steps of the image reading process, in other embodiments, one or more processors may execute the steps of the image reading process dispersedly. The image reading process is executed at the start of image forming process.

FIG. 3 schematically shows positional relationship among the front surface CIS sensor 42, the back surface CIS sensor 43, and the white reference plate 42B and shows relationship with control time of the light source. It is noted that in FIG. 3, the state shown in FIG. 2 is shown reversely left and right. That is, the direction in which the front surface CIS sensor 42 moves from the reference position HP to the reading position DP is shown as rightward.

As shown in FIG. 3, the white reference plate 42B is disposed such that its front edge (SHD plate front edge) is separated from the reference position HP by 2 mm, and its rear edge (SHD plate rear edge) is separated from the reference position HP by 7.6 mm. The back surface CIS sensor 43 is disposed at a position separated from the rear edge of the white reference plate 42B by 17.9 mm and separated from the reading position DP by 10 mm.

### Step S11

First, in step S11, the control portion 7 acquires a request (read request) for reading images of both surfaces of the document sheet. For example, when the user performs an operation to start image formation of images of both surfaces, the control portion 7 acquires the read request. It is noted that at this point in time, the front surface CIS sensor 42 is disposed at the reference position HP, and the light source is in the extinguished (OFF) state.

### Step S12

In step S12, the control portion 7 (the setting processing portion 53) performs the setting process of the front surface CIS sensor 42. Specifically, the setting processing portion 53 performs the initial setting, adjustment, mode setting and the like of the front surface CIS sensor 42. In addition, the setting processing portion 53 generates black reference data for the front surface CIS sensor 42 by extinguishing the light source in a state where the front surface CIS sensor 42 is disposed at the reference position HP. In step S12, the control portion 7 executes the setting process by a well-known method.

### Step S13

In step S13, the control portion 7 (the lighting processing portion 51) lights the light source of the front surface CIS sensor 42 (ON).

### Step S14

In step S14, the control portion 7 (the movement processing portion 52) moves the front surface CIS sensor 42 from the reference position HP to the rear edge of the white reference plate 42B (SHD plate rear edge). While the front surface CIS sensor 42 is moving, the light source maintains the lighting state, and the white reference data for the front surface CIS sensor 42 is generated.

### Step S15

In step S15, the control portion 7 (the lighting processing portion 51) extinguishes the light source of the front surface CIS sensor 42 (OFF). The lighting processing portion 51 extinguishes the light source at the timing when the front surface CIS sensor 42 reaches the edge portion of the white reference plate 42B. In this way, the control portion 7 generates the white reference data by lighting the light source while moving the front surface CIS sensor 42 from the reference position HP to a position at the rear edge of the white reference plate 42B.

### Step S16

In step S16, the control portion 7 (the movement processing portion 52) moves the front surface CIS sensor 42 from the position at the rear edge of the white reference plate 42B (SHD plate rear edge) to the reading position DP. That is, after generating the white reference data while disposing the front surface CIS sensor 42 at the reference position HP, the movement processing portion 52 extinguishes the light source and moves the front surface CIS sensor 42 from the reference position HP to the reading position DP. While the front surface CIS sensor 42 is moving, the light source maintains the extinguished state (see FIG. 3).

### Step S17

In step S17, the control portion 7 (the lighting processing portion 51) lights the light source of the front surface CIS sensor 42. In this way, while the front surface CIS sensor 42 is in a section in which it is moving from the white reference plate 42B to the reading position DP, the control portion 7 extinguishes the light source, and at the timing when the front surface CIS sensor 42 reaches the reading position DP, the control portion 7 lights the light source. After step S17, the control portion 7 moves the process to step S18.

Here, the control portion 7 executes the setting process of the front surface CIS sensor 42 and the setting process of the back surface CIS sensor 43 at the same time (step S21).

### Step S21

In step S21, the control portion 7 (the setting processing portion 53) performs the setting process of the back surface CIS sensor 43. Specifically, the setting processing portion 53 performs the initial setting, adjustment, mode setting and the like of the back surface CIS sensor 43. In addition, the setting processing portion 53 generates black reference data and white reference data for the back surface CIS sensor 43 by lighting the light source of the back surface CIS sensor 43. In step S21, the control portion 7 executes the setting process by a well-known method.

It is noted that in step S21, the control portion 7 may extinguish the light source of the back surface CIS sensor 43 while generating the white reference data by lighting the light source of the front surface CIS sensor 42. That is, the control portion 7 may generate the white reference data for the back surface CIS sensor 43 after generating the white reference data for the front surface CIS sensor 42.

In addition, the control portion 7 may generate the white reference data for the back surface CIS sensor 43 while the front surface CIS sensor 42 is moved from the reference position HP to the reading position DP.

### Step S22

In step S22, the control portion 7 executes the document sheet conveyance process. Specifically, the control portion 7 outputs an instruction to the ADF 1 to convey a document sheet that is the reading object. After step S22, the control portion 7 moves the process to step S18.

### Step S18

In step S18, the control portion 7 starts the reading process of reading images of both surfaces of the conveyed document sheet. Specifically, the control portion 7 executes the shading correction of the image read from the front surface by using the white reference data for the front surface generated by the front surface CIS sensor 42, and executes the shading correction of the image read from the back surface by using the white reference data for the back surface generated by the back surface CIS sensor 43.

As described above, in the image reading method according to the practical example 1, the control portion 7 generates the white reference data for the front surface CIS sensor 42 and the white reference data for the back surface CIS sensor 43 by adjusting ON/OFF time of the light source of the front surface CIS sensor 42 (see FIG. 3). Specifically, while the front surface CIS sensor 42 is in a section in which it is moving from the white reference plate 42B to the reading position DP, the control portion 7 sets the light source to the OFF state. This prevents the light-emitting time of the light source of the back surface CIS sensor 43 and the light-emitting time of the light source of the front surface CIS sensor 42 from overlapping with each other even when the setting process of the back surface CIS sensor 43 is performed while the front surface CIS sensor 42 is moving, thus making it possible to generate the white reference data for the back surface CIS sensor 43 appropriately.

In addition, with the above-described configuration, it is possible to execute the setting process (the process of generating the white reference data) of the front surface CIS sensor 42 and the setting process (the process of generating the white reference data) of the back surface CIS sensor 43 at the same timing, thus making it possible to reduce the image reading time required for the initial document sheet.

### Image Reading Process According to Practical Example 2

FIG. 5 shows an example of the procedure of an image reading process executed by the control portion 7 in the image forming apparatus 100 according to a practical example 2. The positional relationship among the front surface CIS sensor 42, the back surface CIS sensor 43, and the white reference plate 42B is the same as in the configuration shown in FIG. 3.

### Step S31

First, in step S31, the control portion 7 acquires a request (read request) for reading images of both surfaces of the document sheet. For example, when the user performs an operation to start image formation for images of both surfaces, the control portion 7 acquires the read request. It is noted that at this point in time, the front surface CIS sensor 42 is disposed at the reference position HP, and the light source is in the extinguished (OFF) state. Upon acquiring the read request, the control portion 7 executes the setting process of the front surface CIS sensor 42 (S32 to S37) and the setting process of the back surface CIS sensor 43 (S51 to S56).

### Step S32

In step S32, the control portion 7 (the setting processing portion 53) performs the initial setting of the front surface CIS sensor 42.

### Step S33

In step S33, the control portion 7 (the setting processing portion 53) performs the adjustment of the front surface CIS sensor 42.

### Step S34

In step S34, the control portion 7 (the setting processing portion 53) performs the mode setting of the front surface CIS sensor 42.

### Step S35

In step S35, the control portion 7 (the setting processing portion 53) generates the black reference data for the front surface CIS sensor 42. Upon generating the black reference data for the front surface CIS sensor 42, the control portion 7 suspends the setting process of the front surface CIS sensor 42.

The control portion 7 executes the setting process of the back surface CIS sensor 43 at the same timing as of the processes of the steps S32 to S35.

### Step S51

In step S51, the control portion 7 (the setting processing portion 53) performs the initial setting of the back surface CIS sensor 43.

### Step S52

In step S52, the control portion 7 (the setting processing portion 53) performs the adjustment of the back surface CIS sensor 43.

### Step S53

In step S53, the control portion 7 (the setting processing portion 53) performs the mode setting of the back surface CIS sensor 43.

### Step S54

In step S54, the control portion 7 (the setting processing portion 53) generates the black reference data for the back surface CIS sensor 43.

### Step S55

In step S55, the control portion 7 (the lighting processing portion 51) lights the light source of the back surface CIS sensor 43 (ON).

### Step S56

In step S56, the control portion 7 (the setting processing portion 53) generates the white reference data for the back surface CIS sensor 43. Upon generating the white reference data for the back surface CIS sensor 43, the control portion 7 moves the process to step S36 and resumes the setting process of the front surface CIS sensor 42.

### Step S57

In step S57, the control portion 7 executes the document sheet conveyance process. Specifically, the control portion 7 outputs an instruction to the ADF 1 to convey a document sheet that is the reading object. After step S57, the control portion 7 moves the process to step S40.

### Step S36

In step S36, the control portion 7 (the lighting processing portion 51) lights the light source of the front surface CIS sensor 42 (ON). Upon lighting the light source of the front surface CIS sensor 42, the control portion 7 executes the processes of steps S37 and S38.

### Step S37

In step S37, the control portion 7 (the setting processing portion 53) generates the white reference data for the front surface CIS sensor 42. Upon generating the white reference data for the front surface CIS sensor 42, the control portion 7 moves the process to step S39. In this way, the setting processing portion 53 generates the white reference data for the back surface CIS sensor 43 in a state where the front surface CIS sensor 42 is disposed at the reference position HP, and then generates the white reference data for the front surface CIS sensor 42.

### Step S38

In step S38, the control portion 7 (the movement processing portion 52) moves the front surface CIS sensor 42 from the reference position HP to the reading position DP. While the front surface CIS sensor 42 is moving, the light source maintains the lighting state. In this way, after generating the white reference data for the back surface CIS sensor 43, the control portion 7 lights the light source of the front surface CIS sensor 42 and moves the front surface CIS sensor 42 from the reference position HP to the reading position DP.

### Step S39

In step S39, the control portion 7 (the lighting processing portion 51) extinguishes the light source of the front surface CIS sensor 42 (OFF). In this way, in the practical example 2, after the white reference data for the back surface CIS sensor 43 is generated, the front surface CIS sensor 42 is moved to the reading position DP. As a result, there is no need to extinguish the light source of the front surface CIS sensor 42 while the front surface CIS sensor 42 is moving.

### Step S40

In step S40, the control portion 7 starts the reading process of reading images of both surfaces of the conveyed document sheet. Specifically, the control portion 7 executes the shading correction of the image read from the front surface by using the white reference data for the front surface generated by the front surface CIS sensor 42, and executes the shading correction of the image read from the back surface by using the white reference data for the back surface generated by the back surface CIS sensor 43.

As described above, in the image reading method according to the practical example 2, the control portion 7 generates the white reference data for the front surface CIS sensor 42 and the white reference data for the back surface CIS sensor 43 by generating the white reference data for the front surface CIS sensor 42 after completing the process of generating the white reference data for the back surface CIS sensor 43. Specifically, the control portion 7 disposes the front surface CIS sensor 42 at the reference position HP and does not move it therefrom while the white reference data for the back surface CIS sensor 43 is generated, and after the white reference data for the back surface CIS sensor 43 is generated, the control portion 7 generates the white reference data for the front surface CIS sensor 42 and moves the front surface CIS sensor 42 from the reference position HP to the reading position DP. This prevents the light-emitting time of the light source of the back surface CIS sensor 43 and the light-emitting time of the light source of the front surface CIS sensor 42 from overlapping with each other, thus making it possible to generate the white reference data for the back surface CIS sensor 43 appropriately.

In addition, with the above-described configuration, it is possible to execute the setting process (the initial setting, adjustment, mode setting, process of generating the black reference data) of the front surface CIS sensor 42 and the setting process (the initial setting, adjustment, mode setting, process of generating the black reference data) of the back surface CIS sensor 43 at the same timing, thus making it possible to reduce the image reading time required for the initial document sheet.

In the way described above, each time the power of the image forming apparatus 100 enters the ON state or it returns from the sleep mode, the control portion 7 executes the image reading process repeatedly. It is noted that the above-described image reading processes in the practical examples 1 and 2 are presented as an example, and the contents of the processes and the order thereof can be changed as necessary.

As described above, the image forming apparatus 100 includes: the ADF 1 configured to convey a document sheet; the back surface CIS sensor 43 (first reading portion) disposed in the ADF 1 and configured to read an image of the document sheet conveyed by the ADF 1; the front surface CIS sensor 42 (second reading portion) disposed below the first contact glass 411 in such a way as to be reciprocally movable along a scanning direction; the white reference plate 43B (first white reference plate) disposed in the ADF 1 to face the back surface CIS sensor 43; the white reference plate 42B (second white reference plate) disposed in the ADF 1 at the reference position HP that can face the front surface CIS sensor 42; and the control portion 7 configured to light a first light source included in the back surface CIS sensor 43 and generate first white reference data for back surface by using reflected light reflected from the white reference plate 43B, and light a second light source included in the front surface CIS sensor 42 and generate second white reference data for front surface by using reflected light reflected from the white reference plate 42B. In addition, the control portion 7 controls the first light source and the second light source such that a lighting time of the first light source does not overlap with a lighting time of the second light source.

With the above-described configuration, since the lighting time of the light source for generating the white reference data for the front surface CIS sensor 42 does not overlap with the lighting time of the light source for generating the white reference data for the back surface CIS sensor 43, it is possible to generate the white reference data for each of the front surface CIS sensor 42 and the back surface CIS sensor 43 appropriately. It is thus possible to prevent low-quality images from being formed. In addition, with the above-described configuration, it is possible to execute the setting process of the front surface CIS sensor 42 and the setting process of the back surface CIS sensor 43 at the same timing, thus making it possible to reduce the image reading time required for the initial document sheet.

### Appended Notes on the Disclosure

The following notes are appended concerning a summary of the disclosure extracted from the above-described embodiment. It is noted that the configurations and processing functions explained in the following notes can be arbitrarily selected and combined.

### Note 1

An image reading device comprising:
a conveying portion configured to convey a sheet;
a first reading portion disposed in the conveying portion and configured to read an image of a first surface of the sheet conveyed by the conveying portion;
a second reading portion disposed below a contact glass in such a way as to be reciprocally movable along a scanning direction and configured to read an image of a second surface of the sheet;
a first white reference plate disposed in the conveying portion to face the first reading portion;
a second white reference plate disposed in the conveying portion at a reference position that can face the second reading portion; and
a control portion configured to light a first light source included in the first reading portion and generate first white reference data by using reflected light reflected from the first white reference plate, and light a second light source included in the second reading portion and generate second white reference data by using reflected light reflected from the second white reference plate, wherein
the control portion controls the first light source and the second light source such that a lighting time of the first light source does not overlap with a lighting time of the second light source.

### Note 2

The image reading device according to Note 1, wherein
the first reading portion and the first white reference plate are disposed downstream, in a conveyance direction in which the sheet is conveyed, of a reading position at which the second reading portion reads an image of the sheet, and the second white reference plate is disposed downstream of the first reading portion and the first white reference plate in the conveyance direction.

### Note 3

The image reading device according to Note 1 or 2, wherein
the first white reference plate is disposed between the first reading portion and the contact glass.

### Note 4

The image reading device according to any one of Notes 1 to 3, wherein
after generating the second white reference data while disposing the second reading portion at the reference position, the control portion extinguishes the second light source and moves the second reading portion from the reference position to the reading position.

### Note 5

The image reading device according to Note 4, wherein
the control portion extinguishes the second light source at a timing when the second reading portion reaches an edge portion of the second white reference plate.

### Note 6

The image reading device according to Note 4 or 5, wherein
the control portion further generates the first white reference data while moving the second reading portion from the reference position to the reading position.

### Note 7

The image reading device according to any one of Notes 1 to 3, wherein
after generating the first white reference data in a state where the second reading portion is disposed at the reference position, the control portion generates the second white reference data.

### Note 8

The image reading device according to Note 7, wherein
after generating the first white reference data, the control portion further lights the second light source and moves the second reading portion from the reference position to the reading position.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading device comprising:
a conveying portion configured to convey a sheet;
a first reading portion disposed in the conveying portion and configured to read an image of a first surface of the sheet conveyed by the conveying portion;
a second reading portion disposed below a contact glass in such a way as to be reciprocally movable along a scanning direction and configured to read an image of a second surface of the sheet;
a first white reference plate disposed in the conveying portion to face the first reading portion;
a second white reference plate disposed in the conveying portion at a reference position that can face the second reading portion; and
a control portion configured to light a first light source included in the first reading portion and generate first white reference data by using reflected light reflected from the first white reference plate, and light a second light source included in the second reading portion and generate second white reference data by using reflected light reflected from the second white reference plate, wherein
the control portion controls the first light source and the second light source such that a lighting time of the first light source does not overlap with a lighting time of the second light source.

2. The image reading device according to claim 1, wherein
the first reading portion and the first white reference plate are disposed downstream, in a conveyance direction in which the sheet is conveyed, of a reading position at which the second reading portion reads an image of the sheet, and the second white reference plate is disposed downstream of the first reading portion and the first white reference plate in the conveyance direction.

3. The image reading device according to claim 2, wherein
the first white reference plate is disposed between the first reading portion and the contact glass.

4. The image reading device according to claim 2, wherein
after generating the second white reference data while disposing the second reading portion at the reference position, the control portion extinguishes the second light source and moves the second reading portion from the reference position to the reading position.

5. The image reading device according to claim 4, wherein
the control portion extinguishes the second light source at a timing when the second reading portion reaches an edge portion of the second white reference plate.

6. The image reading device according to claim 4, wherein
the control portion further generates the first white reference data while moving the second reading portion from the reference position to the reading position.

7. The image reading device according to claim 2, wherein
after generating the first white reference data in a state where the second reading portion is disposed at the reference position, the control portion generates the second white reference data.

8. The image reading device according to claim 7, wherein
after generating the first white reference data, the control portion further lights the second light source and moves the second reading portion from the reference position to the reading position.

9. An image forming apparatus comprising:
the image reading device according to claim 1; and
an image forming portion configured to form an image on the sheet.

10. An image reading method for, in an image reading device including: a conveying portion configured to convey a sheet; a first reading portion disposed in the conveying portion and configured to read an image of a first surface of the sheet conveyed by the conveying portion; a second reading portion disposed below a contact glass in such a way as to be reciprocally movable along a scanning direction and configured to read an image of a second surface of the sheet; a first white reference plate disposed in the conveying portion to face the first reading portion; and a second white reference plate disposed in the conveying portion at a reference position that can face the second reading portion, reading the image, the image reading method comprising
a control step of lighting a first light source included in the first reading portion and generating first white reference data by using reflected light reflected from the first white reference plate, and lighting a second light source included in the second reading portion and generating second white reference data by using reflected light reflected from the second white reference plate, wherein
in the control step, the first light source and the second light source are controlled such that a lighting time of the first light source does not overlap with a lighting time of the second light source.
